(19) United States
(12) Patent Application Publication
(10) Pub. No.: US 2008/0076507 A1
(43) Pub. Date: Mar. 27, 2008

(54) SYSTEM AND METHOD FOR PROVIDING A VIRTUAL MULTIPLE BALL ROULETTE-STYLE WHEEL IN A GAMING DEVICE

(76) Inventor: Jay Wertheimer, Atlanta, GA (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/382,417

(22) Filed: May 9, 2006

Related U.S. Application Data
(60) Provisional application No. 60/680,188, filed on May 12, 2005.

(51) Int. Cl. A63F 13/00

(52) U.S. Cl. 463/17

(57) ABSTRACT

Method and system for providing a virtual multiple ball roulette-style wheel in a gaming device. The wheel has a center point, at least one circular track and a circular region of cassettes. The circular track and the circular region being centered on the center point. The virtual multiple ball roulette-style wheel may be used in the main game and/or bonus game.

### RELATED APPLICATIONS

The present application claims priority to U.S. Provisional Patent Application Ser. No. 60/680,188 filed May 12, 2005, which is hereby incorporated by reference in its entirety.

### FIELD OF THE INVENTION

The present invention relates generally to gaming devices, and more particularly, to a virtual multiple ball roulette-style wheel for use in a gaming device.

### BACKGROUND OF THE INVENTION

Gambling has historically been a favorite pastime for many (and an obsession for some), and at the time of the present patent application enjoys very rapid growth. More and more local governments, for example, are promoting gambling of various sorts as a tool to generate increased tax revenues. Gambling is also being promoted more and more as a tool for providing income for various Native American groups, sanctioned by the U.S. Federal government. In the private sector as well the public sector, gambling continues to enjoy healthy growth.

One gambling game that has historically enjoyed relative popularity is the game of roulette, wherein wagers are placed on the likelihood of a metal ball, having been propelled around a track in a rotary direction opposite the rotary direction of a central wheel having indentions (cassettes) where the ball can come to rest, landing in one or another of the available final positions. The game of Roulette is described in detail in two references in the possession of and familiar to the inventor. The references are: “Winning Tips for Casino Games” by John Grochowski, and “Beating the Wheel—Winning Strategies at Roulette” by Russel T. Barnhart. Both of these references are incorporated in this specification by reference.

It is well-known in the art that Roulette has recently been slipping in popularity. It is now the least popular gambling game among slot machines, Video Poker, Blackjack, or Craps, each of which is a major casino game. Roulette draws more players than Bacarrat only. Moreover, there are new games recently introduced that also threaten to be more popular than conventional Roulette. One of these is “Caribbean Stud Poker” and another is “Let It Ride”, both of which are known to those with skill in the art.

In Europe, however, Roulette is still very popular. The main reason Roulette is still very popular in Europe is that European Roulette wheels have only one zero, whereas American Roulette wheels have both a zero and a double zero. The American wheels, therefore, reduce the chances of the player winning and substantially improve the house odds.

One attempt to revitalize roulette style gaming is disclosed in U.S. Pat. No. 5,755,440 issued May 26, 1998 to Abraham Sher. The '440 patent discloses a multiple ball, multiple track roulette style wheel which is generally utilized in a standard roulette style table game. While the '440 patent does disclose a new style roulette style game, it has not proved popular or successful.

The present invention aims at one or more problems identified above.

### SUMMARY OF THE INVENTION

In a first aspect of the present invention, a method of implementing a virtual multiple ball roulette-style wheel in a gaming device is provided. The wheel has a center point, at least one circular track and a circular region of cassettes. The circular track and the circular region being centered on the center point. The method including the step of displaying the virtual wheel on the gaming device, establishing rate of rotation of the wheel, rotating the wheel about the center point at the established rate of rotation at a starting time, randomly selecting a first one of the cassettes, and randomly selecting a second one of the cassettes. The method further including the steps of establishing a first time at which a first ball is to be released and responsively releasing the first ball at the first time in the at least one circular track, establishing a second time at which a first ball is to be released and responsively releasing the second ball at the second time in the at least one circular track, moving the first ball around the at least one track and into the first one of the cassettes, and moving the second ball around the at least one track and into the second one of the cassettes.

In a second aspect of the present invention, a system for implementing a virtual multiple ball roulette-style wheel in a gaming device is provided. The system includes a display device and a controller. The display device displays the virtual wheel on the gaming device. The wheel has a center point, at least one circular track and a circular region of cassettes. The circular track and the circular region are centered on the center point. The controller is coupled to the display device for establishing rate of rotation of the wheel, rotating the wheel about the center point at the established rate of rotation at a starting time, randomly selecting a first one of the cassettes, and randomly selecting a second one of the cassettes. The controller also establishes a first time at which a first ball is to be released and responsively releases the first ball at the first time in the at least one circular track and establishes a second time at which a first ball is to be released and responsively releases the second ball at the second time in the at least one circular track. The controller further moves the first ball around the at least one track and into the first one of the cassettes and moves the second ball around the at least one track and into the second one of the cassettes.

In a third aspect of the present invention, a method of providing a bonus game in a gaming device is provided. The method includes the steps of playing a main game; and providing a bonus game in the form of a virtual multiple ball roulette-style wheel in response to a predetermined event.

In a fourth aspect of the present invention, a method of implementing a virtual multiple ball roulette-style wheel is provided. The method includes the step of displaying the virtual wheel on the gaming device. The wheel includes a center point, a circular track and a circular region of cassettes. The circular track and the circular region are centered on the center point. The method further includes the steps of rotating the wheel about the center point, randomly selecting a first one of the cassettes, randomly selecting a second one of the cassettes, and releasing the first and second balls in the circular track. The method further includes the steps of moving the first ball around the circular track and into the first one of the cassettes and moving the second ball around the circular track and into the second one of the cassettes.

In a fifth aspect of the present invention, a system for implementing a virtual multiple ball roulette-style wheel in a gaming device is provided. The system includes a display device and a controller. The device displays the virtual wheel on the gaming device. The wheel has a center point, a circular track and a circular region of cassettes. The circular track and the circular region are centered on the center point. The controller is coupled to the display device for rotating the wheel about the center point, randomly selecting a first one and a second one of the cassettes, releasing the first and second balls in the circular track, moving the first ball around the circular track and into the first one of the cassettes, and moving the second ball around the circular track and into the second one of the cassettes.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is block diagram of a system for implementing a virtual multiple ball roulette-style wheel on a gaming device, according to an embodiment of the present invention;

FIG. 2 is a flow diagram of a method of implementing a virtual multiple ball roulette-style wheel on a gaming device, according to an embodiment of the present invention;

FIG. 3 is a diagrammatic illustration of a virtual multiple ball roulette-style wheel with first and second tracks, according to an embodiment of the present invention;

FIG. 4 is a diagrammatic illustration of a table game with a virtual multiple ball roulette-style wheel with first and second tracks, according to an embodiment of the present invention;

FIG. 5 is a diagrammatical illustration of a slot machine having at least one bonus round, according to an embodiment of the present invention;

FIG. 6 is a partial illustration of a virtual doulette wheel for use in a bonus round of the slot machine of FIG. 5, according to an embodiment of the present invention;

FIG. 7 is an icon or symbol set for use in the slot machine of FIG. 5, according to an embodiment of the present invention;

FIG. 8 is a screen shot of the main game of the slot machine of FIG. 5, according to an embodiment of the present invention;

FIG. 9 is a first screen shot of a second bonus game of the slot machine of FIG. 5, according to an embodiment of the present invention;

FIG. 10 is a second screen shot of the second bonus game of the slot machine of FIG. 5, according to an embodiment of the present invention;

FIG. 11 is a third screen shot of the second bonus game of the slot machine of FIG. 5, according to an embodiment of the present invention;

FIG. 12 is a fourth screen shot of the second bonus game of the slot machine of FIG. 5, according to an embodiment of the present invention; and,

FIG. 13 is a diagrammatical illustration of a multi-station video slot machine, according to an embodiment of the present invention.

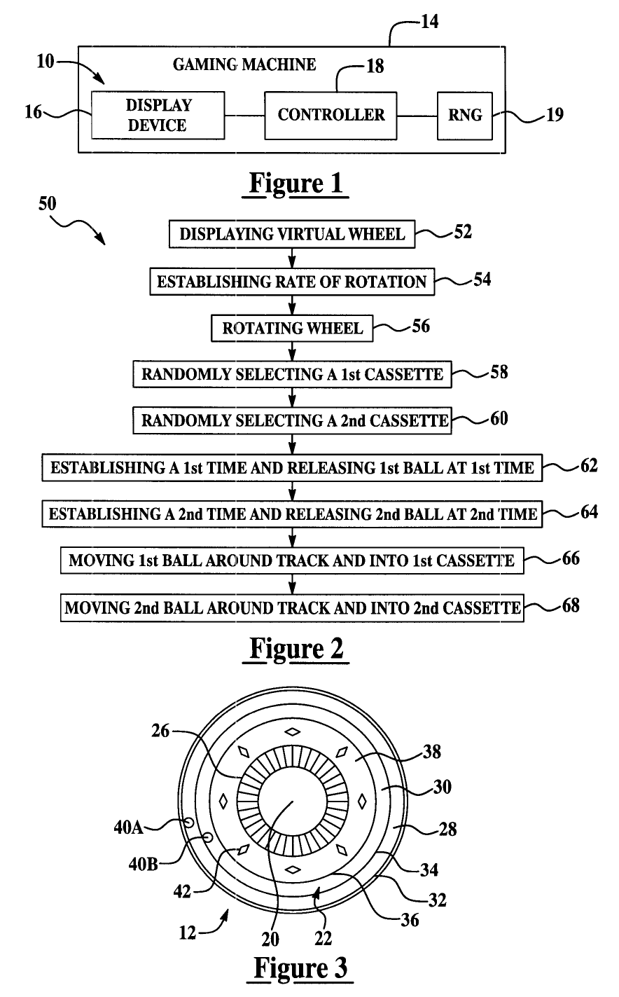

### DETAILED DESCRIPTION OF INVENTION

With reference to the drawings, and in operation, the present invention provides a system 10 for implementing a virtual multiple ball roulette-style wheel 12 (see FIG. 3) in a gaming device 14. The gaming device 14 may be utilized for wagering or non-wagering. Wagers may be made physically as in a the table form of a roulette and/or made electronically or virtually.

The system 10 includes a display device 16 and a controller 18. The display device 16 displays the virtual wheel 12 on the gaming device 14. The wheel 12 has a center point 20, at least one circular track 22 and a circular region 24 of cassettes 26. The circular track 22 and the circular region 24 are centered on the center point 20.

In the illustrated embodiment, the virtual wheel 12 includes first and second outer tracks 28, 30. The outer edge of the virtual wheel 12 is defined by an outer wall 32. The first track 28 is defined by the outer wall 32 and central wall 34. The second track 30 is defined by the central wall 34 and inner wall 36. A tapered portion 38 separates the inner wall 36 and the circular region 24 of cassettes 26. The cassettes 26 are the final resting places for first and second balls 40A, 40B. As described below, the balls 40A, 40B are virtual balls implemented on the display device 16. Projections 42 may be included at various points on the wheel 12. In the illustrated embodiment, projections 42 are shown in the tapered portion 38.

The controller 18 is coupled to the display device 16 controls operation of the virtual wheel 12, i.e., for rotating the wheel 12, propelling the balls 40A, 40B onto the rotating wheel, and moving the balls on the wheel 12 until the balls 40A, 40B rest in one of the cassettes 26.

The controller 18 is a logic device, such as a microprocessor based microcontroller capable of controlling the display device 16 to operate the virtual wheel 12. The system 10 may also include a random number generator (RNG) 19 which is utilized to generated random numbers to implement one or more aspects of the virtual multiple ball roulette-style wheel. In one embodiment, the RNG 19 is an independent device coupled to the controller 18 as is known in the art. In another embodiment, the RNG 19 is implemented by the controller 18.

The display device 16 may include a dynamic holographic display; a display monitor, such as a LCD panel, plasma, other flat screen monitor, or other suitable display; or combination thereof.

With reference to FIG. 2, a method 50 of implementing the virtual multiple ball roulette-style wheel 12 in the gaming device 14. Generally, the method 50 will be implemented, at least partially, in a computer program application being run on the controller 18.

In a first step 52, the virtual wheel 12 is displayed on the gaming device 14. In a second step 54, a rate of rotation of the wheel 12 is established. In a third step 56, the wheel 12 is rotated about the center point 20 at the established rate of rotation at a starting time. In one embodiment, the starting time is determined by the controller 18 automatically based on the timing of a prior event. In another embodiment, the starting time may be established as a function of user input (either the player or the dealer, where appropriate). For example, the dealer may have access to a button which, when actuated, starts rotation of the wheel.

In a fourth step 58, a first one of the cassettes 26 is selected. In a fifth step 60, a second one of the cassettes 26 is selected.

In a sixth step 62, a first time, at which the first ball 40A is to be released, is established and the first ball 40A is responsively released at the first time in the at least one circular track 22. In a seventh step 64, a second time, at which the second ball 40B is to be released, is established and the second ball 40B is responsively released at the second time in the at least one circular track 22.

In one embodiment, the first and second balls 40A, 40B are propelled when released onto the wheel 12 in a rotary direction. Typically, the rotary direction of the first and second balls 40A, 40B will be opposite to the rotation of the wheel 12.

In one embodiment, the first and second balls 40A, 40B are released on a single track. One of the first and second balls 40A, 40B may be of a different color or may have another mark or indicia to identify it from the other one of the first and second balls 40A, 40B. In another embodiment, the first ball 40A is released on the first track 28 and the second ball 40B is released on the second track 30.

In one aspect the first time and the second time are determined relative to the starting time. In one embodiment, the first and second balls 40A, 40B are released at the same time such that the first time is equal to the second time. In another embodiment, the first and second balls 40A, 40B are released at different times, i.e., the first time is not equal to the second time.

In one embodiment, the first and second times are predetermined. In another embodiment, the first and second times are randomly determined within a predetermined range. In still another embodiment, the first and second times may be established as a function of a user (either player or dealer) input. In other words, the dealer, for example, may press a button to release one or both of the balls 40A, 40B.

In an eighth step 66, the first ball 40A is moved around the at least one track and into the first one of the cassettes 26. In a ninth step 68, the second ball 40B is moved around the at least one track and into the second one of the cassettes 26.

Generally, the motion of the first and second balls 40A, 40B will be controlled to simulate the motion of a real roulette ball.

The balls 40A, 40B will begin moving about the track or respective track 28, 30 in a motion opposite the rotation of the wheel 12. As such, the balls may appear to “lose” energy until they leave the tracks 28, 30, travel across the tapered section 38 and settle into the respective selected cassette 26.

The method may also include the step of establishing a total rotation time and stopping rotation of the wheel after the total rotation time. The total rotation time may be a predetermined constant or may be randomly determined during a predetermined range.

In one embodiment the rate of rotation is constant. In another embodiment, the rate is not constant and may increase from zero rotation to a maximum rate of rotation and then decrease down to zero from the maximum rate of rotation.

In one embodiment, the first one of the cassettes 26 is selected through a first random number and the second one of the cassettes 26 is selected through a second random number.

In another embodiment the first one of the cassettes 26 and the second one of the cassettes 26 are selected by the generation of a single random number.

In one embodiment, each of the cassettes 26 has an equal chance of being selected.

In another embodiment, at least one of the cassettes has a greater or less chance of being selected.

The virtual multiple ball roulette-style wheel 12 may be implemented with a single track (in which all balls start travel thereon) or with a track for each of the balls. In the illustrated embodiment, the virtual multiple ball roulette-style wheel 12 is shown with first and second balls 40A, 40B with associated first and second tracks 28, 30, respectively. Such a virtual multiple ball roulette-style wheel may be referred to as “Doulette” wheel. Although the following describe a Doulette wheel, it is for description purposes only.

The virtual Doulette wheel may be implemented as a stand alone game, implemented on a computer and/or computer network or may be incorporated into any type of gaming device 14, including, but not limited, to table games, a video slot machine, a reel slot machine, and multiple player games.

### Table Game

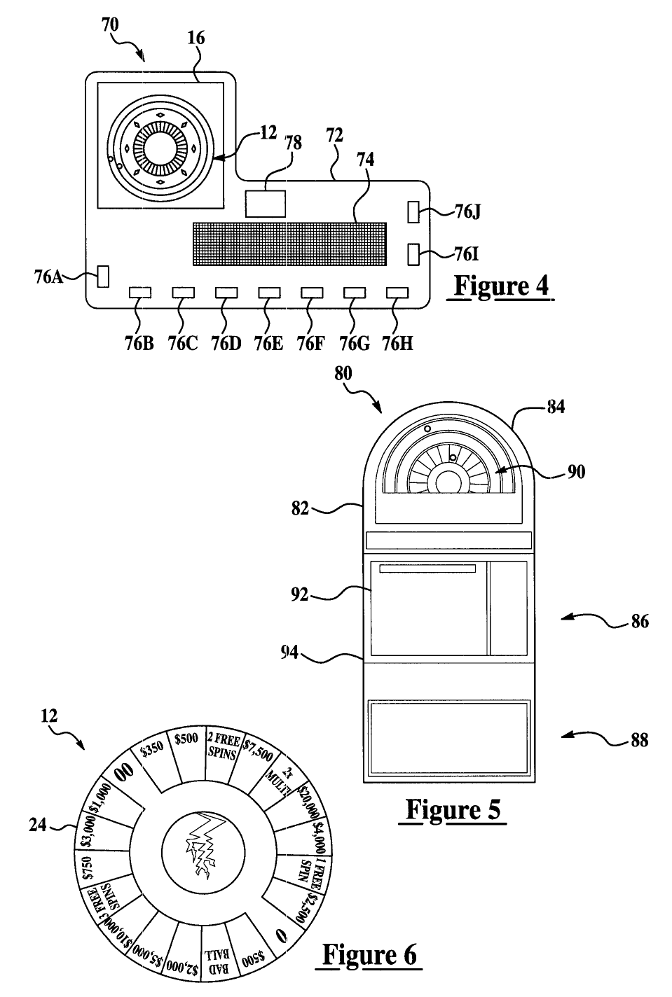

With respect to FIG. 4, an exemplary Doulette table 70 is shown. Outline 72 is the outer periphery of the table 70 which is shown in the traditional “L” shape of a roulette table, although the present invention is not limited to any particular shape. The display device 16 with the virtual Doulette wheel 12 is mounted to the table 70 such that the surface of the display device 16 is relatively flush with the surface of the table. A betting field 74, generally printed on the felt or covering of the table 70, may be of many different forms within the scope of the invention, including those betting fields well-known in the art.

Positions 76A-76I are positions for extra bets. In some embodiments these positions may be permanently marked as to the bet represented by placing money or chips or scrip on one or more of the betting positions.

In one embodiment, a dealer is required. As in a traditional Roulette game, the dealer manages all bets and payouts and controls operating of the system 10. A dealer interface 78 may be provided which allows the dealer to initiate operation of the Doulette wheel 12. The dealer interface 78 will generally be coupled to the controller 18 and may be implemented in any suitable fashion, e.g., a touchscreen interface or a series of mechanical buttons or switches to control operation of the system 10.

In another embodiment, the controller 18 controls operation of the system 10 including starting operation of the wheel. No dealer may be required. Positions 76A-76J may include player interfaces for placing bets.

### Video or Real Slot Machines

With reference to FIGS. 5-7, the virtual multiple ball roulette-style wheel 12, such as a Doulette wheel, may be incorporated into a mechanical reel or video slot machine 80. While a video slot machine 80 is shown, the mechanical reel slot machine implementation shares many of the same features.

The video slot machine 80 includes a game cabinet 82 which includes a top box 84, a middle portion 86 and a bottom portion 88. The game cabinet 82 generally houses all of the electronics and other components of the machine 80. The top box 84 generally includes a display or top glass 90, which is generally backlit, which includes the name of the game and other game related static graphics, as is well known in the art.

The middle portion 86 includes a main display 92, such as a display monitor, LCD panel, touchscreen display, or other suitable device. The middle portion 86 may also include an input panel 94 for interaction with a player, as is known in the art. For example, the input panel 94 may include buttons for selecting paylines or how many paylines and the amount of a wager. The input panel 94 may also include a “max bet” and a “spin” button. A coin acceptor may also be included. Input buttons may also be implemented on the touchscreen display as is well known in the art.

The Doulette wheel may be implemented as a main game or any other kind of game. The main game may be any type of game, e.g., a mechanical or video slot game, a video card game, such as poker or blackjack, or any similar game. The Doulette wheel may be implemented as a bonus game which are is triggered in response to some predetermined event. The predetermined may be, but is not necessarily, a predetermined event within the main game. As discussed below, in the video slot implementation, the Doulette bonus game may be implemented and shown on a main display 82 of the slot machine. Alternatively, the Doulette bonus game may be shown on a secondary display and/or the display of a player tracking device. In a mechanical reel slot implementation, the Doulette bonus game may be shown in a smaller display (not shown) and/or the display of a player tracking device (not shown).

As is known in the prior art, in the main game of the slot machine 80, after the reels are spun, predetermined symbols or combinations or symbols appearing on a selected payline designates a win for the player, resulting in a payout determined as a function of a predetermined pay table.

Typically, bonus games are triggered by the appearance of a designated symbol or pattern of symbols appearing in the stopped reel positions of the main slot game.

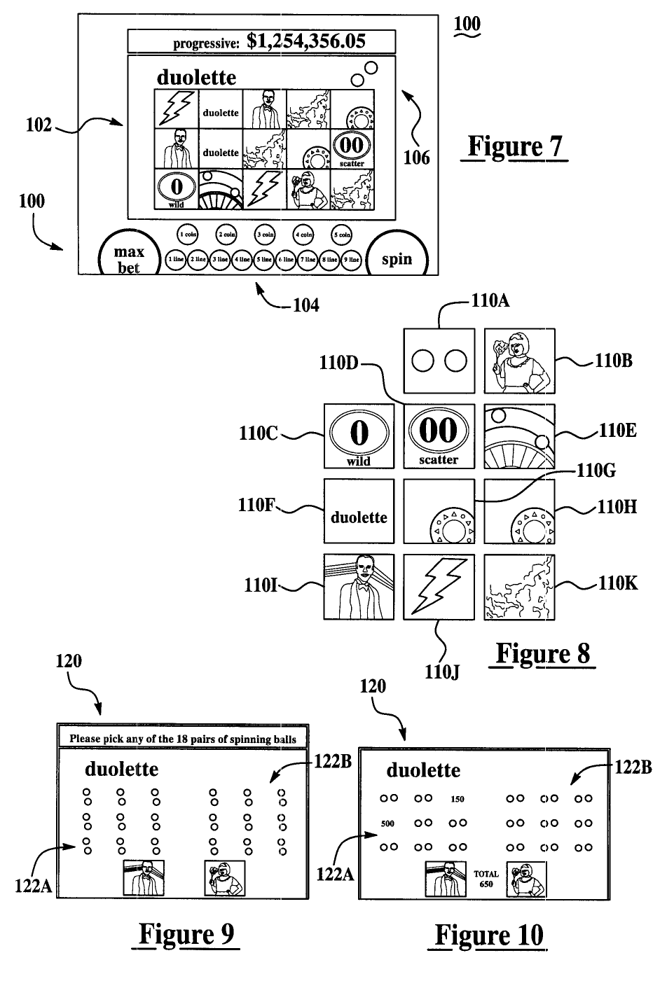

With specific reference to FIGS. 5-8, an exemplary Doulette Video Slot Machine implementation will be shown and described. However, it should be noted that the present invention is not limited to any single implementation.

With specific reference to FIG. 7, a first screen shot 100 of the main display 92 showing a typical reel layout 102 of a video slot implementation. It should be noted that the illustrated embodiment shows a five reel, although the present invention is not limited to such. Touchscreen buttons 104 for allowing the player to make wagers, select the number of paylines to play and to initiate game play may be provided, as is known in the art. The gaming device 14 may be linked to a progressive jackpot. The amount of the progressive jackpot may be indicated in a progressive jackpot section 106 located above the reel layout 102 in the illustrated embodiment.

With particular reference to FIG. 9, an exemplary set of symbols or icons 110 (labeled individually as (110A-110K) are shown. In the described embodiment, certain symbols may have additional attached features, as described below.

Doulette Square Symbol 110F—Five Doulette Square Symbol 110F on any payline pays the large payout, e.g., 50,000 coins or credits.

Doulette Bonus Wheel 110E—3 or more left to rights on any payline initiates the Doulette bonus game (see below).

Doulette Double White Duo Balls Symbol 110A—3 or more Duo Ball Symbols 110A, starting left to right, on any payline initiates second bonus game (see below). The number of Duo Balls on the payline which initiates the second bonus game will affect the number of coins or credits available to win in the bonus round, i.e., the more Duo Ball Symbols 110A on the payline the larger the potential payout in the bonus round will increase

Double Green Scatter Bonus Symbol 110D—Three or more Double Green Scatter Bonus Symbols 110D in any reel position may initiate a respective scatter bonus.

Single Green Zero Wild Ball Symbol 110C-A single Green Zero Wild Ball Symbol 110C in any position may act as a wild symbol for all or certain of the other symbols.

The French Doulette Croupier Symbol 110I—3 or more of the Croupier Symbols 110I on any payline left to right will signify a payout. When this occurs, the Croupier may (with a French accent) request tips.

The Lovely French Maid Symbol 110B—3 or more of the Maid Symbols 110B on any payline left to right will signify a payout. When this occurs, the Maid may seductively use her dust ruffle and say “Ooh La La”.

The Thunder Cloud Symbol 110K—3 or more of the Cloud Symbols 110K on any payline left to right will signify a payout (but may be less then the Croupier and/or Maid payouts). When this occurs, the sound of thunder and rain may be played.

The Lightning Bolt Symbol 110J—3 or more of the Lightning Symbols 110J on any payline left to right will signify a payout (but may be less then the Croupier and/or Maid payouts). When this occurs, bolts of lightning may be displayed at some a designated location on the main display 92.

Red and Black Symbols 110G, 110H: 3 or more of the of one of the symbols 110G, 110H on any payline left to right will signify a payout (generally the smallest payout).

With particular reference to FIG. 4, when the Doulette Bonus Round is triggered (see above), the reel layout 102 on the main display 92 is replaced with the Doulette wheel 12. In the illustrated embodiment, there are 20 cassettes 26 in the circular region 24 (shown in FIG. 4). In the Doulette Bonus Round, the player gets a predetermined number of spins of the Doulette wheel 12, e.g., one or three spins. Each cassette has either a coin or credit amount or other instructions described below, plus a “0” cassette and a “00” cassette.

“0” and “00” Cassettes—When one of the balls 40A, 40B lands in the “0” cassette and the other balls 40A, 40B lands in the “00” cassette, the player wins the progressive jackpot. If one ball 40A, 40B lands on the “0” cassette and the other ball 40A, 40B does not land in the “00” cassette, the second ball plays where it lands.

1, 2, or 3 Free Spins—Player gets 1, 2, or 3 free spins of the Doulette Wheel 12.

2× Multiplier—Player multiplies the amount of the win from the other ball (if any)

Bad Ball Bankruptcy—Pay $0, unless other ball lands in “0” or “00”. Payout maxes out at $100. If second ball lands in 2×, then payout maxes out at $225.

With particular reference to FIGS. 9-12, a secondary bonus game may be provided. The second bonus game may be triggered during the main game as described above. When the second bonus game is triggered, the reel layout 102 on the display device 16 is replaced with a second bonus screen 120. In the second bonus screen 120, first and second sets of bonus icons 122A, 122B. In the illustrated embodiment, the bonus icons 122A, 122B show an animated pair of balls. However, other icons may also be used. Instructions 124 appear at the top of the second bonus screen 120. The instructions instruct the player to pick (by touching) “any of the 18 pairs of spinning balls”. Once the player touches one of the pairs, it is replaced (through an animation) with one of the following: (1) a credit or coin amount, (2) the phrase “DUO DO-OVER”, or (3) “BUSTED BALLS”.

If a credit or coin amount appears, then the player wins that amount and gets to pick another set of spinning balls (see FIG. 10).

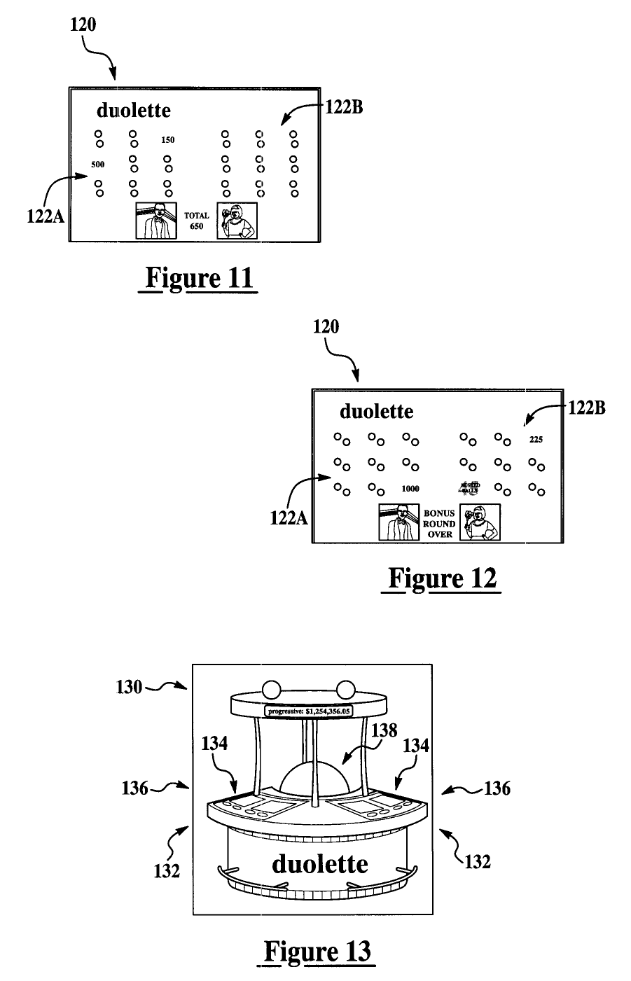

If the words “DUO DO-OVER” appear, the screen 120 is cleared and a new set of 18 pairs of spinning balls appears (see FIG. 11). The player gets to start over, while retaining any credits or coins previously won in the bonus round.

If the words “BUSTED BALLS” appear, the bonus round is over and the player may get to keep any credits or coins previously won (see FIG. 12). When this occurs an animation and/or voice-over between the dealer/croupier and waitress at the bottom of the screen 120 may be played.

As discussed above, the virtual multiple ball roulette-style wheel 12 may be implemented in a variety of gaming devices or machines 12. With particular reference to FIG. 13, a multi-player gaming device 130 is shown. In the illustrated embodiment, the multi-player gaming device 130 is circular with a plurality of gaming stations 132 located around the perimeter. Each gaming station 132 may include a display device 134 and a user interface 136. In the illustrated embodiment, each gaming station 132 is adapted to provide a video slot machine game. The virtual multiple ball roulette-style wheel 12 may be provided in a central location 138 on a central display screen or underneath a bubble 140. The virtual multiple ball roulette-style wheel 12 may be at least partially implemented using a dynamic holographic device as discussed above. In the illustrated embodiment, the virtual multiple ball roulette-style wheel 12 implements a bonus game as described above.

Other implementations may also be implemented. For example, the virtual multiple ball roulette-style wheel 12 may be implemented as a scratch off lottery ticket.

The second bonus game, as described above, may also be implemented as a scratch off lottery ticket.

In some gaming jurisdictions, only certain types of games are allowed. For example, some jurisdictions may only allow Bingo based games. In these jurisdictions, Bingo based games which appear to the user as another type game, such as a video slot machine are allowed. In another embodiment, the virtual multiple ball roulette-style wheel 12 is implemented to show the results of an underlying Bingo game.

Obviously, many modifications and variations of the present invention are possible in light of the above teachings. The invention may be practiced otherwise than as specifically described within the scope of the appended claims.

What is claimed is:

1. A method of implementing a virtual multiple ball roulette-style wheel in a gaming device, the wheel having a center point, at least one circular track and a circular region of cassettes, the circular track and the circular region being centered on the center point, comprising:
displaying the virtual wheel on the gaming device;
establishing rate of rotation of the wheel;
rotating the wheel about the center point at the established rate of rotation at a starting time;
randomly selecting a first one of the cassettes;
randomly selecting a second one of the cassettes;
establishing a first time at which a first ball is to be released and responsively releasing the first ball at the first time in the at least one circular track;
establishing a second time at which a second ball is to be released and responsively releasing the second ball at the second time in the at least one circular track;
moving the first ball around the at least one track and into the first one of the cassettes; and,
moving the second ball around the at least one track and into the second one of the cassettes.

2. A method, as set forth in claim 1, wherein the virtual wheel is displayed on a display of the gaming device.

3. A method, as set forth in claim 1, wherein the virtual wheel is displayed using a dynamic holographic display.

4. A method, as set forth in claim 1, including the steps of establishing a total rotation time and stopping rotation of the wheel after the total rotation time.

5. A method, as set forth in claim 1, wherein the rate of rotation is constant.

6. A method, as set forth in claim 1, wherein the rate of rotation is not constant.

7. A method, as set forth in claim 1, wherein the first time and the second time are established with respect to the starting time.

8. A method, as set forth in claim 1, wherein the at least one track includes a first track and a second track, the first ball being released in the first track and the second ball being released in the second track.

9. A method, as set forth in claim 1, wherein the step of selecting a first one of the cassettes includes the step of generating a first random number and the step of selecting a second one of the cassettes includes the step of generating a second random number.

10. A method, as set forth in claim 1, including the step of generating a random number, wherein the first one of the cassettes and the second one of the cassettes are determined as a function of the random number.

11. A method, as set forth in claim 1, wherein each of the cassettes has an equal chance of being selected.

12. A method, as set forth in claim 1, wherein at least one of the cassettes has a greater or lesser chance of being selected.

13. A system for implementing a virtual multiple ball roulette-style wheel in a gaming device, comprising:
a display device for displaying the virtual wheel on the gaming device, the wheel having a center point, at least one circular track and a circular region of cassettes, the circular track and the circular region being centered on the center point; and,
a controller coupled to the display device for establishing rate of rotation of the wheel, rotating the wheel about the center point at the established rate of rotation at a starting time, randomly selecting a first one of the cassettes, and randomly selecting a second one of the cassettes, for establishing a first time at which a first ball is to be released and responsively releasing the first ball at the first time in the at least one circular track and establishing a second time at which a second ball is to be released and responsively releasing the second ball at the second time in the at least one circular track, and for moving the first ball around the at least one track and into the first one of the cassettes and moving the second ball around the at least one track and into the second one of the cassettes.

14. A system, as set forth in claim 13, wherein the display device includes a dynamic holographic display.

15. A system, as set forth in claim 13, wherein the display device is one of a display monitor or a LCD panel, plasma, or other flat screen monitor.

16. A system, as set forth in claim 13, the controller for establishing a total rotation time and stopping rotation of the wheel after the total rotation time.

17. A system, as set forth in claim 13, wherein the rate of rotation is constant.

18. A system, as set forth in claim 13, wherein the rate of rotation is not constant.

19. A system, as set forth in claim 13, wherein the first time and the second time are established with respect to the starting time.

20. A system, as set forth in claim 13, wherein the at least one track includes a first track and a second track, the first ball being released in the first track and the second ball being released in the second track.

21. A system, as set forth in claim 13, wherein the controller selects a first one of the cassettes by generating a first random number and selects a second one of the cassettes by generating a second random number.

22. A system, as set forth in claim 13, the controller for generating a random number, wherein the first one of the cassettes and the second one of the cassettes are determined as a function of the random number.

23. A system, as set forth in claim 13, wherein each of the cassettes has an equal chance of being selected.

24. A system, as set forth in claim 13, wherein at least one of the cassettes has a greater or lesser chance of being selected.

25. A method of providing a bonus game in a gaming device, comprising:
playing a main game; and,
providing a bonus game in the form of a virtual multiple ball roulette-style wheel in response to a predetermined event.

26. A method, as set forth in claim 25, wherein the predetermined is related to the main game or is not related to the main game.

27. A method, as set forth in claim 25, wherein the virtual multiple ball roulette-style wheel includes a center point, at least one circular region centered on the center point, the method including the steps of:
displaying the virtual wheel on the gaming device;
establishing rate of rotation of the wheel;
rotating the wheel about the center point at the established rate of rotation at a starting time;
randomly selecting a first one of the cassettes;
randomly selecting a second one of the cassettes;
establishing a first time at which a first ball is to be released and responsively releasing the first ball at the first time in the at least one circular track;
establishing a second time at which a second ball is to be released and responsively releasing the second ball at the second time in the at least one circular track;
moving the first ball around the at least one track and into the first one of the cassettes; and,
moving the second ball around the at least one track and into the second one of the cassettes.

28. A method, as set forth in claim 27, including the steps of establishing a total rotation time and stopping rotation of the wheel after the total rotation time.

29. A method, as set forth in claim 27, wherein the at least one track includes a first track and a second track, the first ball being released in the first track and the second ball being released in the second track.

30. A method, as set forth in claim 27, wherein the step of selecting a first one of the cassettes includes the step of generating a first random number and the step of selecting a second one of the cassettes includes the step of generating a second random number.

31. A method, as set forth in claim 27, including the step of generating a random number, wherein the first one of the cassettes and the second one of the cassettes are determined as a function of the random number.

32. A method, as set forth in claim 27, wherein each of the cassettes has an equal chance of being selected.

33. A method, as set forth in claim 27, wherein at least one of the cassettes has a greater or lesser chance of being selected.

34. A method of implementing a virtual multiple ball roulette-style wheel, comprising:
displaying the virtual wheel on the gaming device, the wheel having a center point, a circular track and a circular region of cassettes, the circular track and the circular region being centered on the center point;
rotating the wheel about the center point;
randomly selecting a first one of the cassettes;
randomly selecting a second one of the cassettes;
releasing the first and second balls in the circular track;
moving the first ball around the circular track and into the first one of the cassettes; and,
moving the second ball around the circular track and into the second one of the cassettes.

35. A method, as set forth in claim 34, wherein the step of selecting a first one of the cassettes includes the step of generating a first random number and the step of selecting a second one of the cassettes includes the step of generating a second random number.

36. A method, as set forth in claim 34, including the step of generating a random number, wherein the first one of the cassettes and the second one of the cassettes are determined as a function of the random number.

37. A method, as set forth in claim 34, wherein each of the cassettes has an equal chance of being selected.

38. A method, as set forth in claim 34, wherein at least one of the cassettes has a greater or lesser chance of being selected.

39. A system for implementing a virtual multiple ball roulette-style wheel in a gaming device, comprising:
a display device for displaying the virtual wheel on the gaming device, the wheel having a center point, a circular track and a circular region of cassettes, the circular track and the circular region being centered on the center point; and,
a controller coupled to the display device for rotating the wheel about the center point, randomly selecting a first one and a second one of the cassettes, releasing the first and second balls in the circular track, moving the first ball around the circular track and into the first one of the cassettes, and moving the second ball around the circular track and into the second one of the cassettes.

40. A system, as set forth in claim 39, the controller in selecting a first one of the cassettes and a second one of the cassettes generates a first random number and a second random number, respectively.

41. A system, as set forth in claim 39, the controller for generating a random number, wherein the first one of the cassettes and the second one of the cassettes are determined as a function of the random number.

42. A system, as set forth in claim 39, wherein each of the cassettes has an equal chance of being selected.

43. A system, as set forth in claim 39, wherein at least one of the cassettes has a greater or lesser chance of being selected.
